(19) United States
(12) Patent Application Publication
(10) Pub. No.: US 2012/0048750 A1
(43) Pub. Date: Mar. 1, 2012

(54) REDUCED WEAR COMPONENT FOR USE IN HIGH PRESSURE HYDROGEN ENVIRONMENTS

(75) Inventors: Thad Adams, Aiken, SC (US); Poh-Sang Lam, Martinez, GA (US); Rana F. Mohtadi, Northville, MI (US)

(73) Assignees: Savannah River Nuclear Solutions LLC, Aiken, SC (US); Toyota Motor Engineering & Manufacturing North America, Inc., Erlanger, KY (US)

(21) Appl. No.: 12/873,762

(22) Filed: Sep. 1, 2010

(51) Int. Cl. B65D 85/00; B23P 25/00

(52) U.S. Cl. 206/6; 29/458

(57) ABSTRACT

The present invention discloses a hydrogen storage device having a storage component containing gaseous hydrogen at a pressure greater than 500 pounds per square inch (psi), the storage component having a moving component therewithin. The moving component is made from an iron-base alloy and has a moving surface that is displaced relative to a mating surface during operation of the hydrogen storage device. The moving surface and the mating surface are subject to wear when the moving surface is displaced relative to the mating surface. In addition, the moving surface and/or mating surface has a coating that reduces wear between the two surfaces.

### STATEMENT AS TO RIGHTS TO INVENTIONS MADE UNDER FEDERALLY SPONSORED RESEARCH AND DEVELOPMENT

This invention was made with Government support under Contract No. DE-AC09-08SR22470 awarded by the United States Department of Energy. The Government has certain rights in the invention.

### FIELD OF THE INVENTION

The present invention relates to a component for use in high pressure hydrogen gas environments, and in particular, to components exhibiting reduced wear in high pressure hydrogen gas environments.

### BACKGROUND OF THE INVENTION

Interest for the use of hydrogen as an energy source has increased as concerns related to the burning of fossil fuels continue. With an increase in the use of hydrogen as a fuel, storage of liquid and/or gaseous hydrogen will require development of new technologies and/or equipment that can efficiently and safely store hydrogen, operate in high pressure hydrogen environments, etc. For example, hydrogen embrittlement of iron-base alloys is known to be a problem in high pressure hydrogen gas environments. In addition, when two metallic surfaces move relative to each other in a high pressure hydrogen gas environment, the amount or degree of wear between the two surfaces is known to be exacerbated. As such, heretofore technologies have attempted to reduce or eliminate the use of metallic components in high pressure hydrogen gas environments. However, in some instances the use of metallic components is required and/or is desired. Therefore, metallic components that exhibit reduced wear within high pressure hydrogen gas environments would be desirable.

### SUMMARY OF THE INVENTION

The present invention discloses a hydrogen storage device having a storage component containing gaseous hydrogen at a pressure greater than 500 pounds per square inch (psi), the storage component having a moving component therewithin. The moving component is made from an iron-base alloy and has a moving surface that is displaced relative to a mating surface during operation of the hydrogen storage device. The moving surface and the mating surface are subject to wear when the moving surface is displaced relative to the mating surface. In addition, the moving surface has a coating thereon, the coating being a diamond like carbon coating, a nitrided plasma coating or the like.

In some instances, the pressure of the gaseous hydrogen is greater than 2,500 psi. In other instances, the pressure of the gaseous hydrogen is greater than 5,000 psi. The storage component can be a hydrogen storage tank and the iron-base alloy can be a ferritic stainless steel, an austenitic stainless steel, etc. The moving component may or may not be a solenoid valve, a pressure reducing valve, a check valve and the like, and in some instances, the mating surface is also coated with a diamond like carbon coating, a nitrided plasma coating or the like.

A process for reducing wear within a high pressure hydrogen environment is also provided, the process including providing a moving component to be used in high pressure hydrogen. The moving component has a moving surface that is displaced relative to a mating surface when the component is used within the high pressure hydrogen environment. The process further includes coating the moving surface with a diamond like carbon coating, a nitrided plasma coating or the like. Thereafter, the moving component is installed within the high pressure hydrogen environment and put into use.

### BRIEF DESCRIPTION OF THE DRAWINGS

FIG. 1 is a schematic drawing illustrating a hydrogen storage tank with a moving component;

FIG. 2 is a schematic representation of a solenoid valve;

FIG. 3 is a schematic representation of a moving surface displaced relative to a mating surface;

FIG. 4 is a schematic representation of a coating on the moving surface shown in FIG. 3;

FIG. 5 is a schematic representation of a coating on the moving surface and the mating surface shown in FIG. 3;

FIGS. 6A-6B are photographs of a pin and disk where tested in a high pressure hydrogen gas environment;

FIGS. 6C-6D are profilometer profiles of the disk and pin shown in FIGS. 6A and 6B, respectively;

FIGS. 7A-7B are photographs of a disk and pin where tested in a high pressure hydrogen gas environment;

FIG. 7C is a profilometer profile of the disk shown in FIG. 7A;

FIGS. 8A-8B are photographs of a disk and pin where tested in a high pressure hydrogen gas environment; and

FIGS. 8C-8D are profilometer profiles of the disk and pin shown in FIGS. 8A-8B, respectively.

### DETAILED DESCRIPTION OF THE INVENTION

The present invention discloses an apparatus and a process for reducing wear between two moving surfaces within a high pressure hydrogen gas environment. As such, the present invention has utility as a component for a motor vehicle that uses hydrogen as a fuel source.

The invention can include a hydrogen storage device having a storage component such as a hydrogen storage tank that contains liquid and/or gaseous hydrogen at a pressure greater than 500 pounds per square inch (psi). Within the storage component or in fluid communication with the high pressure hydrogen is a moving component made from an iron-based alloy. The moving component can have a moving surface that is displaced relative to a mating surface during operation of the hydrogen storage device. The moving surface and/or the mating surface can be subject to wear when the moving surface is displaced relative to the mating surface and the wear between the two surfaces is reduced and/or eliminated by a diamond like carbon coating, a nitrided plasma coating or the like being present on the moving surface and/or mating surface of the component.

In some instances, the storage component can contain gaseous hydrogen at a pressure greater than 2,500 psi, while in other instances the storage component can contain gaseous hydrogen at a pressure greater than 5,000 psi. The moving component, and in particular the moving surface and/or mating surface, can be made from a ferritic stainless steel, an austenitic stainless steel, etc. For example and for illustrative purposes only, the moving component can be a solenoid valve, a pressure reducing valve, a check valve and the like.

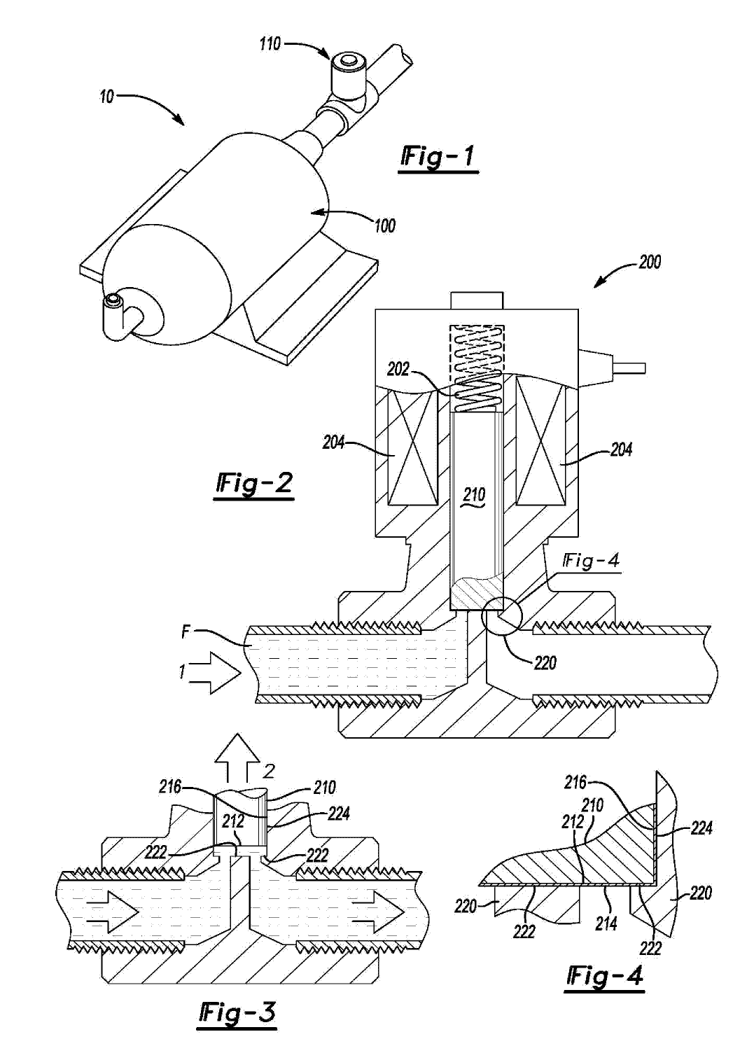

Turning now to FIG. 1, a schematic representation of a hydrogen storage device is shown generally at reference numeral 10. The hydrogen storage device 10 can include a hydrogen storage tank 100 that can contain high pressure hydrogen. Within the hydrogen storage tank 100 and/or in fluid communication therewith, a component 110 can be present. The component 110 can have two parts or subcomponents (not shown).

For example and for illustrative purposes only, FIGS. 2 and 3 provide a schematic diagram of a solenoid valve 200, the solenoid valve 200 having a solenoid rod 210 and a valve body 220. A fluid F can flow into the valve 200 as shown by arrow 1 and be prevented from flowing past the solenoid rod 210 by contact between an end or contact surface 212 of the rod 210 and a valve seat surface 222 of the valve body 220. It is appreciated that the solenoid rod 210 can be biased against the valve seat surface 222 using a spring 202. In addition, electrical current can be passed through an electrical coil shown schematically at reference numeral 204 and thereby provide an electric field that reduces the strength of the spring 202 and thus the biasing force against the solenoid rod 210. In such an event, pressure of the fluid F against the end surface 212 of the rod 210 affords for movement of the rod 210 in an upward direction 2, thereby allowing the fluid F to flow past the rod 210. In this manner, a valve is provided that can allow and/or stop the flow of hydrogen from a hydrogen storage tank.

Repeated use of the solenoid valve 200 affords for contact and relative movement between the end or contact surface 212 and the seating surface 222. In addition, the solenoid rod 210 can have a side surface 216 that can contact and/or rub against a surface 224 of the valve body 220. As such, wear of one or both of the surfaces can occur, especially if one or both of the surfaces is an iron-base alloy and/or is subject to hydrogen embrittlement.

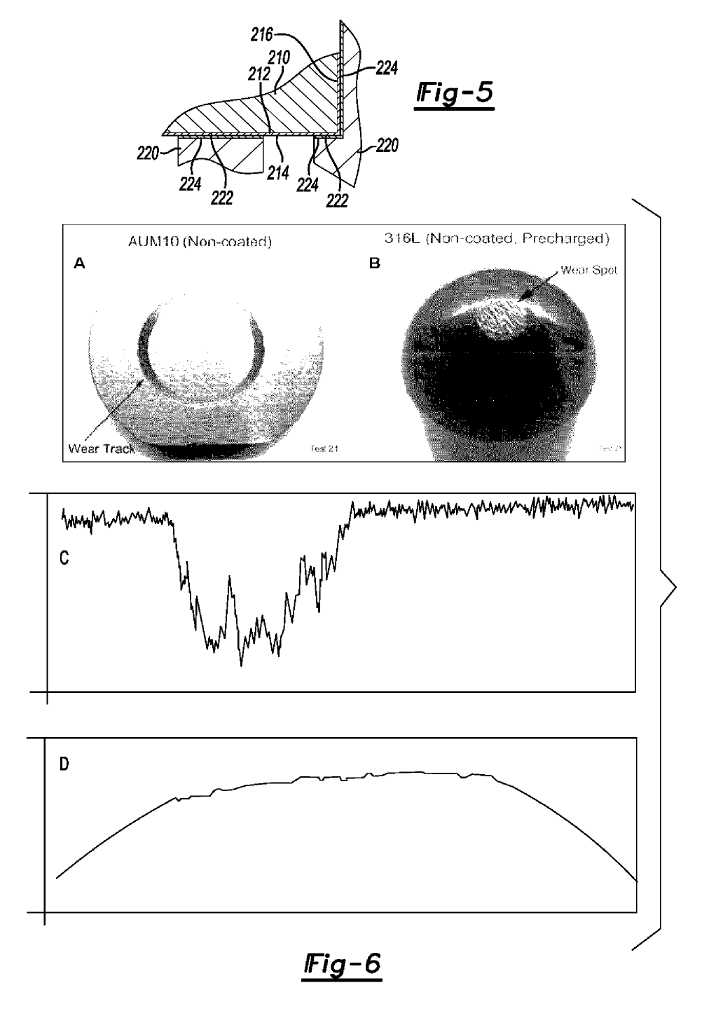

Looking now at FIG. 4, the solenoid rod 210 with the contact surface 212 has a coating 214 thereon. The coating can be any coating known to those skilled in the art, illustratively including a diamond like carbon coating, a plasma nitrided coating or the like. Any process known to those skilled in the art can be used to provide the coating and the mating surface 222 can optionally have a coating 224 as shown in FIG. 5. In this manner, two surfaces that come into contact with each other, are displaced relative to each other and/or rub up against each other are coated with a coating that affords reduced wear between the two surfaces.

In order to better illustrate and yet not limit the scope of the invention in any way, experimental data are provided that demonstrate the reduction of wear between two iron-base components in a high pressure hydrogen gas environment. In particular, a disk made out of ferritic steel and subjected to a disk-pin wear test in a hydrogen gas environment having a pressure of 2,000 psi is shown in FIG. 6A. The pin used during the test (FIG. 6B) was made from 316L austenitic stainless steel and had a load of 0.1 pounds (lb). Neither the disk nor the pin were coated and significant sliding wear is visible in the photographs of FIGS. 6A and 6B. In addition, FIG. 6C is a profilometer profile showing the extent of wear along the wear track of the ferritic steel disk and FIG. 6D is a profilometer profile showing the metal loss at the wear spot of the 316L austenitic stainless steel pin.

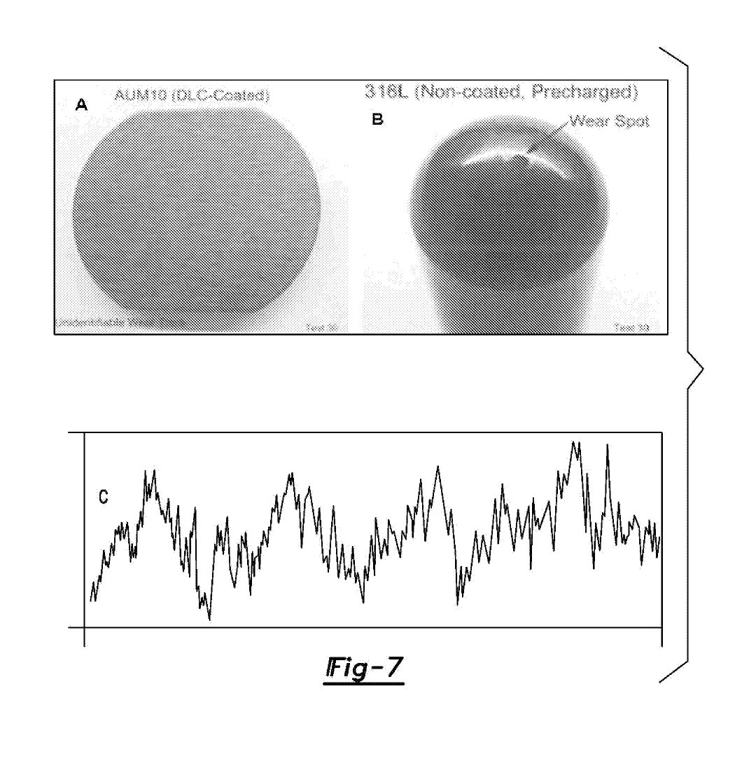

In comparison, a disk-pin wear test in a 2,000 psi hydrogen environment and containing a ferritic steel disk having a diamond like carbon coating is shown in FIG. 7A. An un-coated 316L austenitic stainless steel pin having a load of 0.1 lb was used in the test. As shown by the profilometer profile in FIG. 7C, the coated disk did not exhibit any noticeable or measurable wear. In addition, the wear spot shown on the 316L austenitic stainless steel pin was much smaller than the wear spot exhibited for the un-coated disk sample test shown in FIGS. 6A-6D.

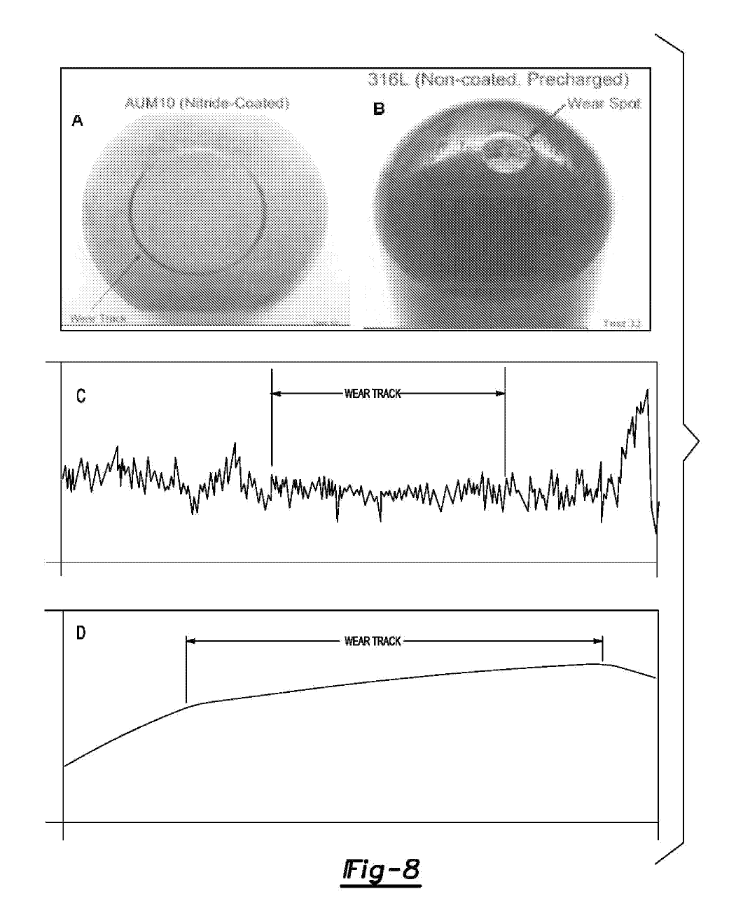

A wear test using a plasma nitride coated ferritic steel disk and an un-coated 316L austenitic stainless steel pin was also performed. FIGS. 8A and 8B illustrate photographs of the tested plasma nitride coated ferritic steel disk and the un-coated 316L austenitic stainless steel pin, respectively. As shown in these two photographs, the disk and the pin exhibited less wear than in the un-coated disk test but more wear than in the diamond like carbon coated disk test.

FIG. 8C provides a profilometer profile across the wear track of the disk shown in FIG. 8A and FIG. 8D shows a profilometer profile for the wear spot shown on the pin in FIG. 8B. It is appreciated that the profiles confirm the results shown in the photographs, i.e. the wear exhibited by the disk and the pin, the disk and the pin exhibited less wear than in the un-coated disk test but more wear than in the diamond like carbon coated disk test. As such, coating of metallic surfaces subject to wear in high pressure hydrogen gas environments can reduce wear therebetween.

The invention is not restricted to the illustrative examples or embodiments described above. The examples or embodiments are not intended as limitations on the scope of the invention. Methods, processes, apparatus, compositions, and the like described herein are exemplary and not intended as limitations on the scope of the invention. Changes herein and other uses will occur to those skilled in the art. The scope of the invention is defined by the scope of the claims.

We claim:

1. A hydrogen storage device comprising:
a storage component containing gaseous hydrogen at a pressure greater than 500 pounds per square inch (psi); and
a moving component within said storage component, said moving component made from an iron-base alloy and having a moving surface that is displaced relative to a mating surface during operation of the hydrogen storage device;
said moving surface and said mating surface subject to wear when said moving surface is displaced relative to said mating surface;
said at least one of said moving surface and said mating surface having a coating that reduces wear between said moving surface and said mating surface.

2. A hydrogen storage device of claim 1, wherein said moving surface has said coating that reduces wear between said moving surface and said mating surface.

3. A hydrogen storage device of claim 1, wherein said mating surface has said coating that reduces wear between said moving surface and said mating surface.

4. A hydrogen storage device of claim 1, wherein both said moving surface and said mating surface have said coating that reduces wear between said moving surface and said mating surface.

5. The hydrogen storage device of claim 1, wherein said coating is selected from a group consisting of a diamond like carbon coating and a nitrided plasma coating.

6. The hydrogen storage device of claim 1, wherein said pressure of gaseous hydrogen is greater than 2,500 psi.

7. The hydrogen storage device of claim 1, wherein said pressure of gaseous hydrogen is greater than 5,000 psi.

8. The hydrogen storage device of claim 1, wherein said storage component is a hydrogen storage tank.

9. The hydrogen storage device of claim 1, wherein said iron-base alloy is a ferritic stainless steel.

10. The hydrogen storage device of claim 1, wherein said iron-base alloy is an austenitic stainless steel.

11. The hydrogen storage device of claim 1, wherein said moving component is a solenoid valve.

12. The hydrogen storage device of claim 1, wherein said moving component is a pressure reducing valve.

13. A process for reducing wear within a high pressure hydrogen environment, the process comprising:
providing a moving component to be used in a high pressure hydrogen environment, the moving component having a moving surface that is displaced relative to a mating surface when the moving component is used in the high pressure hydrogen environment;
coating at least one of the moving surface and the mating surface with a coating selected from a group consisting of a diamond like coating and a nitrided plasma coating;
installing the moving component in a high pressure hydrogen environment having a hydrogen pressure of greater than 500 psi; and
using the moving component in the high pressure hydrogen environment, the moving surface and the mating surface having reduced wear when the moving surface is displaced relative to a mating surface during use of the moving component.

14. The process of claim 13, wherein the hydrogen pressure is greater than 2,500 psi.

15. The process of claim 13, wherein the hydrogen pressure is greater than 5,000 psi.

16. The process of claim 13, wherein the high pressure hydrogen environment is within a hydrogen storage tank.

17. The process of claim 13, wherein the moving component is made from an iron-base alloy.

18. The process of claim 17, wherein the iron-base alloy is a ferritic stainless steel.

19. The process of claim 17, wherein the iron-base alloy is an austenitic stainless steel.

20. The process of claim 17, wherein the moving component is a solenoid valve.

21. The process of claim 17, wherein the moving component is a pressure reducing valve.
